(19) United States
(12) Patent Application Publication
(10) Pub. No.: US 2006/0223024 A1
(43) Pub. Date: Oct. 5, 2006

(54) Temperature-regulated heat-emitting device and method of whitening teeth

(76) Inventor: Mark Hochman, Lake Success, NY (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/120,113

(22) Filed: May 2, 2005

Related U.S. Application Data
(60) Provisional application No. 60/666,039, filed on Mar. 29, 2005.
(60) Provisional application No. 60/668,664, filed on Apr. 6, 2005.

(51) Int. Cl. A61C 3/00; A61C 5/00

(52) U.S. Cl. 433/32; 433/215

(57) ABSTRACT

A toothbrush is provided that is employed with a bleaching agent in an oral cavity of a subject. The toothbrush includes a body having a head and a heating element disposed with the head. The heating element is configured to emit heat for heat activation of the bleaching agent. The head includes an engagement portion, which is configured for engagement with at least a portion of the oral cavity. A thermal sensor is disposed with the head. The thermal sensor is configured to sense temperature adjacent to the engagement portion of the head. A temperature adjacent the engagement portion is regulated by a thermal feedback circuit communicating with the thermal sensor and a thermostat disposed with the body to control heat activation of the bleaching agent. The heating element may include a light-emitting source configured to emit heat.

### CROSS REFERENCE TO RELATED APPLICATIONS

This Patent Application claims priority from U.S. Provisional Patent Application Ser. No. 60/666,039, filed on Mar. 29, 2005 and U.S. Provisional Application Ser. No. 60/668,664, filed on Apr. 6, 2005, the contents of which are incorporated herein by reference in their entirety.

### BACKGROUND

1. Technical Field

The present disclosure relates to dental health, dental cosmetics, dental apparatus and dental compositions. More specifically, the present disclosure is directed to teeth whitening via heat activation including the cosmetic whitening of teeth through thermal chemical activation processes and related dental compositions, such as tooth bleaching compositions, used in combination with a teeth whitening apparatus. Additionally, the disclosure provides a safe, comfortable experience for patients including those experiencing gingival recession, which can expose sensitive root structures.

2. Description of the Related Art

Increasingly, it has become popular to whiten teeth that are naturally off white or have become stained by smoking or food intake. To whiten teeth in the past, people either have capped teeth or had veneers placed over them, which both entail costly and involved dental procedures. More recently, chemical bleaching of teeth has allowed people to whiten their teeth without resorting to these previously costly and involved dental procedures.

In early bleaching methods, dental patients desiring to have their teeth bleached had to utilize conventional dental office bleaching techniques. These techniques usually involved placing a peroxide solution on the teeth, protecting the sensitive soft tissues with a ligated rubber dam, and applying unregulated heat or light to the solution. Unfortunately, the lights used in dental office procedures are high power, high voltage lights that desiccate teeth and cause greater postoperative sensitivity. Additionally, such dental office treatments are extremely time consuming as they typically required multiple appointments for a significant color change. The need for multiple professional office visits results in a procedure that is costly. Despite the expense and other problems associated with professional whitening of teeth, these professional methods are primarily concerned with the whitening of the buccal, facial surface only.

Because of the time consuming nature of these multiple office visits and costs associated therewith, there has been a growing interest within the dental profession for in-home tooth bleaching products and methods. One particular in-home approach embeds various bleaching agents onto substrates such as fabric or fiber strips that a patient applies to their teeth. The most commonly used dental bleaching agents are 10% carbamide peroxide (CO(NH2)2 H2 O2), also called urea hydrogen peroxide, hydrogen peroxide carbamide, and perhydrol-urea.

While useful results have been experienced using the foregoing in-home techniques, their effectiveness has been largely dependent upon such factors as type and intensity of tooth enamel stain, bleaching agent contact time, and the amount of available active ingredient in the bleaching agent. Unfortunately, despite improvements in these in-home methods, there remain disadvantages and limitations to in-home bleaching products and techniques. A significant disadvantage of the known in-home approaches is the lack of patient compliance due to the long application or contact time required.

Other attempts to overcome the disadvantages of the prior art include light-emitting whitening devices that use light energy to activate a bleaching agent. These types of devices use light to catalyze the bleaching agent at a specific wavelength. These light-emitting type devices can also emit unregulated thermal energy having a temperature that is not controlled. Light-emitting sources that are unable to control a specified range of temperature can degrade the effectiveness of the desired chemical reaction. Further, light application devices typically direct light within a straight line of access to the point of activation, resulting in a non-efficient use of energy.

In addition, since oral health has continued to improve in this country and around the world, many patients possess a partial or full compliment of their dentition. However, over the years the process of gingival recession is known to occur to a segment of our population. Recession of gums exposes the sensitive roots of teeth, making tooth sensitivity a particularly troubling issue. As sensitive roots become exposed to the oral cavity, hot and/or cold sensitivity may become problematic. Sensitivity to hot and/or cold prevents patients from properly cleaning their remaining teeth and gums. This is exacerbated during normal brushing with conventional toothbrushes.

Gingival health is controlled by maintaining a balance between micro-organisms of the intra-oral cavity. The condition of gingivitis and periodontitis affects millions of people in all countries around the world. The regulation of these micro-organisms directly affects the disease process as well as the general health of the oral cavity. Reducing the numbers of micro-organisms and pathogens in the oral cavity will have a beneficial effect on the health of the gums and teeth.

It should therefore be appreciated that what is needed in the art are teeth whitening apparatus, compositions and related methods that facilitate faster and more efficient treatment of tooth surfaces. Such teeth whitening apparatus, compositions and methods should provide a safe, comfortable patient experience with greater compliance and satisfaction.

Therefore, it would be desirable to overcome the disadvantages and drawbacks of the prior art with a teeth whitening apparatus that can be employed with bleaching compositions and related methods that employ heat activation to facilitate fast and efficient treatment of tooth surfaces. Such teeth whitening apparatus, compositions, and methods would provide a safe, comfortable patient experience with greater compliance and satisfaction. It would be desirable if the teeth whitening apparatus included a temperature-regulated, heat-emitting toothbrush that activates a chemical bleaching composition through controlled heat activation. A heat-emitting source of the toothbrush would generate and emit heat energy to activate the bleaching composition. It would be highly desirable if the teeth whitening apparatus, composition and methods prevent tissue damage and enable use by persons that suffer from hot and/or cold sensitivity, such as those who experience gingival recession that exposes sensitive root structures, to achieve the principles of the present disclosure. It is contemplated that the teeth whitening apparatus and its constituent parts are easily and efficiently manufactured and assembled.

### SUMMARY

Accordingly, a teeth whitening apparatus is provided that can be employed with bleaching compositions and related methods that use heat activation to facilitate fast and efficient treatment of tooth surfaces for a safe, comfortable patient experience with greater compliance and satisfaction for overcoming the disadvantages and drawbacks of the prior art. Desirably, the teeth whitening apparatus includes a temperature-regulated, heat-emitting toothbrush that activates a chemical bleaching composition through controlled heat activation. A heat-emitting source of the toothbrush generates and emits heat energy to activate the bleaching composition. Most desirably, the teeth whitening apparatus, composition and methods prevent tissue damage and enable use by persons that suffer from hot and/or cold sensitivity, such as those who experience gingival recession that can expose sensitive root structures, to achieve the principles of the present disclosure. The teeth whitening apparatus is easily and efficiently manufactured and assembled. The present disclosure resolves related disadvantages and drawbacks experienced in the art.

In one particular embodiment, in accordance with the present disclosure, a heat-emitting toothbrush is provided that includes a head composed of bristles and having the ability to maintain a specified range of temperature at the head and bristles for a specified purpose. The heat source emits heat energy in a temperature range that is controlled. It is contemplated that the temperature may be controlled for maintenance with a range of about 85° to about 130° Fahrenheit, although according to a particular application, other ranges are envisioned.

An electric source is provided within a handle or body of the toothbrush. One feature of providing a heat-emitting toothbrush head is to provide a thermal catalyst for activation of bleaching agents and intra-oral compounds, for example, peroxide based compounds. The heat activation of these agents and other chemicals allows catalyzation of a chemical reaction via heat initiation. Another feature of providing a thermal heat-emitting toothbrush head is for patient comfort for those individuals with tooth sensitivity as a result of gingival recession or other oral pathologies that lead to increased tooth sensitivity to hot and/or cold.

The teeth whitening apparatus and methods described provide an innovative technology to activate a chemical compound within the oral cavity. The device allows compounds such as hydrogen peroxide based gels or dentifrices to more efficiently catalyze and release active ingredients enabling them to produce the desired whitening effect. This device also allows patients with thermal sensitivity, as a result of gingival recession and root exposure, to more comfortably use a toothbrush to maintain optimal dental health.

The teeth whitening apparatus, compositions and methods disclosed embody improvements over the prior art by enabling a safer, more reliable activation of chemical processes through the application of thermal heat within a regulated range of temperature. In addition, the teeth whitening apparatus, compositions and methods disclosed provide a comfortable system for cleaning teeth and gums for those patients that exhibit tooth sensitivity related to hot and/or cold. The teeth whitening apparatus, compositions and methods disclosed include several benefits and features including:
1. Allowing the use of heat activated chemicals, or chemical compounds that can be catalyzed for specific therapeutic applications in the oral cavity by topical placement of an innovative heat-emitting toothbrush device;
2. Allowing the use of medications intra-orally that are activated via the use of heat from a heat-emitting toothbrush device;
3. Allowing patients with hot and/or cold sensitivity to more effectively brush teeth by utilizing a heat-emitting toothbrush in a regulated range of temperature to raise or lower the temperature of the agent, gel, etc. to a desirable physiological range;
4. Improving circulation by direct heat emission produces a dilation of the capillary bed within the soft tissues and gums of the oral cavity, thereby improving general oral health;
5. By utilizing a heat emitting source, this configuration results in softening the bristles of a toothbrush to make the bristles less abrasive to use; and
6. Facilitating a phase change of a chemical compound or bleaching agent, such as from a gel to a liquid of a lower viscosity so that the compound or agent can be more readily distributed about the teeth. This distribution of a gel or compound for greater teeth coverage, results in a lower amount of gel or compound being used. For example, the heating of a hard wax or compound to a soft, pliable or workable material is contemplated.

Further, the use of a heat-emitting source allows tissues adjacent, that are not within a direct line of sight, to benefit from the heat energy and thereby allows a more effective manner of chemical activation to occur by use of a direct and indirect thermal sources.

In addition, the heat-emitting toothbrush is controlled via an internal thermostat regulation that will not allow temperatures to exceed safe levels, preventing damage to the soft tissues and patient's body. A thermal feed-back loop circuitry prevents temperatures from rising beyond a specified range ensuring greater control of the desired chemical reaction of the compound used within the oral cavity.

The current device will also enable those patients that are hot and/or cold sensitive to utilize a heat-emitting toothbrush that will make tooth brushing comfortable and safe.

The present disclosure is directed to a heat-emitting toothbrush and method of chemical activation of compounds used within the oral cavity. An example of which is the use of dental tooth whitening in which the heat from the toothbrush is utilized to catalyze the activation of a whitening compound, for example, hydrogen peroxide based chemicals, carbamide peroxide, calcium peroxide, etc.

A heat source, such as, for example a heat-emitting diode can be contained within a body of the toothbrush and may be disposed in a head of the toothbrush, and may include a sensor in the head. Alternatively, the heat source may be disposed in the handle or neck of the toothbrush with corresponding structure to provide heat to the head of the toothbrush. Heat is transferred and radiated from the head of the toothbrush to within and around the bristles of the toothbrush. It is contemplated that filaments within the bristles directly transfer heat to the chemical compounds and soft tissues.

It is also contemplated that the heat-emitting toothbrush may have a beneficial effect on the circulation of the soft tissues, gums and periodontium, enhancing circulation to the tissues. The use of the heat-emitting toothbrush improves circulation to the gum tissues and has a beneficial effect on the general health of the gingival tissues.

In addition, the heat-emitting toothbrush, by producing a rise in temperature, can result in greater circulation that can allow more effective resistance to infection. Using the heat-emitting toothbrush also raises the temperature of the oral cavity to destroy microorganisms that are pathologic in nature.

In another embodiment, the teeth whitening apparatus is employed with a bleaching agent. The teeth whitening apparatus includes a body having a head and a heating element that transmits heat energy. A temperature adjacent the heating element is regulated to control heat activation of the bleaching agent.

In another embodiment, a method for whitening teeth is disclosed. The method includes the steps of: providing a teeth whitening apparatus including a body having a head and a heating element that transmits heat energy, wherein a temperature adjacent the heating element is regulated to control heat activation of the bleaching agent; providing a bleaching agent; applying the bleaching agent to teeth; engaging the teeth, applied with bleaching agent, with the head; and transmitting heat energy from the heating element, wherein a temperature adjacent the heating element is regulated to control heat activation of the bleaching agent.

In another embodiment, the teeth whitening apparatus includes a body including a thermostat and a thermal sensor. A temperature adjacent the heating element is regulated by the thermostat and the thermal sensor to control heat activation of the bleaching agent.

In another embodiment, in accordance with the present disclosure, a temperature-regulated, light-emitting toothbrush is provided that includes a working end or head composed of bristles. The toothbrush has the ability to maintain a specified range of temperature while emitting visible light at the head and bristles for a specified purpose. The temperature-regulated light source emits heat energy in a temperature range that is controlled. It is contemplated that the temperature may be controlled for maintenance with a range of 70° to 140° Fahrenheit, although according to a particular application, other ranges are envisioned.

Alternatively, the bristles, disposed with the head or working end, may be rotatable via a gear mechanism or alternate linking structure. The gear mechanism may activate the bristles via manual and/or motorized structure that can include the necessary electronics and/or processor circuitry to enable activation of the bristles. The bristles may be disposed in various arrangements and orientations, including spaced apart bristle sets. The activation of the bristles may include various forms of movement including rotatable, vertical, horizontal and elliptical. Activation of the bristles may also include vibratory movement in various directions. Motorized or other mechanical movement of the bristles may be connected to circuitry with a thermal sensor such that a specific regulated temperature or temperature range causes shut-off of bristle activation. Alternatively, the bristles may include continuous movement and/or vibration. The bristles may be heated with a filament and/or contain a therapeutic agent.

An electric source is provided within a handle or body of the toothbrush. One feature of providing a heat-emitting toothbrush head is to provide a thermal catalyst for activation of bleaching agents and intra-oral compounds, for example, peroxide based compounds. The light source can be of visible light within any range of wavelength that produces heat as its by-product during use. The heat activation of the bleaching agents and other chemicals allows catalyzation of a chemical reaction via heat initiation. The device is temperature-regulated via a feedback circuitry design to maintain a specified range of temperature during use. The toothbrush is directly controlled by temperature within a specified range. Another feature of providing a thermal heat-emitting toothbrush head is for patient comfort for those individuals with tooth sensitivity as a result of gingival recession or other oral pathologies that lead to increased tooth sensitivity to hot and/or cold. The toothbrush may be battery operated, rechargeable and usable with a recharging base.

The teeth whitening apparatus and method described provide an innovative means to activate a chemical compound within the oral cavity. The device allows compounds such as hydrogen peroxide based gels or dentifrices to more efficiently catalyze producing the desired whitening effect in a shorter period of time. This device also allows patients with thermal sensitivity, as a result of gingival recession and root exposure, to more comfortably use a toothbrush to maintain optimal dental health.

Another embodiment provides a second mode that may differ from the range defined in the first mode (whitening). This second mode would be specific to optimize the effect of reducing the number of micro-organisms in the intra-oral cavity by a temperature-regulated light emitting device.

The teeth whitening apparatus, compositions and methods disclosed embody improvements over the prior art by enabling a safer, more reliable activation of chemical processes through the application of thermal heat within a regulated range of temperature. In addition, the teeth whitening apparatus, compositions and methods disclosed provide a comfortable system for cleaning teeth and gums for those patients that exhibit tooth sensitivity related to hot and/or cold. The teeth whitening apparatus also provides other safety features such as preventing damage to patient tissues by maintaining a specific therapeutic range of working temperature. Further, the teeth whitening apparatus can achieve optimum results for those procedures based on chemical reactions that require a specific range of temperature to achieve an optimal outcome. This configuration can also use temperature and light to catalyze bleaching agents.

The temperature-regulated, light-emitting toothbrush is controlled via an internal thermostat regulation that will not allow temperatures to exceed safe levels preventing damage to the soft tissues and patients body. A thermal feedback loop circuitry prevents temperatures from raising beyond a specified range ensuring greater control on the desired chemical reaction of the compound used within the oral cavity. The temperature-regulated, light-emitting device overcomes these limitations by directly regulating the temperature at which the light-emitting device functions within.

Aspects of the present disclosure are directed to a temperature-regulated, light-emitting device and method of chemical activation of compounds used within the oral cavity, i.e. teeth whitening. An example is the use of dental tooth whitening in which the visible light gives off heat and energy utilized to catalyze the activation of a whitening compound.

The sensor feeds temperature information back to the circuit board to control the light source producing heat within the system. It is also conceivable that filaments at the source can feed information to a sensor within the body of the device or directly to the circuitry board to regulate the temperature via light-emitting source.

Temperature can be controlled by on/off circuitry connected to the light-emitting source, which can lower or raise the intensity of the light-emitting source through the reduction of power to the light-emitting source. Temperature is regulated via the light-emitting source to maintain a specified range of temperature output from the light-emitting source.

The use of a temperature-regulated toothbrush in combination with a light-emitting source reduces the numbers of micro-organisms, which improves gingival health by reducing those organisms that contribute to gingivitis, periodontitis, halitosis (bad breath) and other ailments that are associated with pathogens in the oral cavity. The use of the heat-emitting toothbrush improves circulation to the gum tissues and has a beneficial effect on the general health of the gingival tissues.

In another embodiment, a method for whitening teeth is disclosed. The method includes the steps of: providing a teeth whitening apparatus including a body having a head and a light-emitting source that transmits heat energy, wherein a temperature adjacent the light-emitting source is regulated to control heat activation of a bleaching agent; providing a bleaching agent; applying the bleaching agent to teeth; engaging the teeth, applied with the bleaching agent, with the head; and transmitting heat energy from the light-emitting source, wherein a temperature adjacent to the light-emitting source is regulated to control heat activation of the bleaching agent.

In another embodiment, the teeth whitening apparatus includes a body having a head and a light-emitting source that transmits heat energy, the body further including a thermostat and a thermal sensor. A temperature adjacent the light-emitting source is regulated by the thermostat and the thermal sensor to control heat activation of the bleaching agent.

In another embodiment, in accordance with the principles of the present disclosure, a toothbrush employed with a bleaching agent in an oral cavity of a subject is provided. The toothbrush includes a body having a head and a heating element disposed with the head. The heating element is configured to emit heat for heat activation of the bleaching agent. The head includes an engagement portion, which is configured for engagement with at least a portion of the oral cavity. A thermal sensor is disposed with the head. The thermal sensor is configured to sense temperature adjacent the engagement portion of the head. A temperature adjacent to the engagement portion is regulated by a thermal feedback circuit communicating with the thermal sensor and a thermostat disposed with the body to control heat activation of the bleaching agent. The heating element may include a light-emitting source configured to emit heat.

The engagement portion may include bristles. The bristles may be rotatable. The engagement portion can be moveable relative to the head. The engagement portion can be moveable via motorized actuation. The engagement portion may be capable of vibration. The engagement portion may be configured for engagement with teeth and gums of the subject. At least one of the bristles may have a filament configuration that includes an embedded conductor that generates heat such that the filament bristle is configured to emit heat for heat activation of the bleaching agent. At least one of the bristles may have a filament configuration that includes an embedded conductive element that monitors temperature adjacent the engagement portion and communicates such temperature to the thermal feedback circuit. At least one of the bristles may include a fiber-optic filament.

The toothbrush may include an electronic circuit disposed within the body, which communicates with the thermal sensor, the thermostat, and an energy source for controlling operation of the toothbrush. The thermostat can have a predetermined upper limit and a predetermined lower limit. The temperature adjacent the engagement portion may be regulated in a range of about 70° to about 140° F.

Alternatively, the heating element includes filaments disposed with and configured to heat the bristles. The thermal sensor can include filaments disposed with and configured to sense temperature adjacent the bristles.

The toothbrush may include a rheostat temperature control disposed with the body that communicates with the electronic circuit in a configuration that controls the temperature adjacent the engagement portion at a predefined value. The toothbrush may also include a timer disposed with the body that communicates with the electronic circuit in a configuration that transmits heat energy for a predetermined amount of time. The electronic circuit may communicate with a device, disposed with the body, that generates an audible signal upon duration of the predetermined amount of time.

In an alternate embodiment, a method for whitening teeth is provided that includes the steps of: providing a toothbrush, similar to those described; providing a bleaching agent; applying the bleaching agent to at least one tooth of the oral cavity; engaging the at least one tooth, applied with bleaching agent, with the engagement portion of the head of the toothbrush; transmitting heat from a heating element of the toothbrush, wherein a temperature adjacent to the engagement portion is regulated to control heat activation of the bleaching agent.

The method of whitening teeth may include the step of emitting heat from the heat element in a configuration that softens bristles of the toothbrush. Additionally, this step can also include improving gingival health by reducing an amount of micro-organisms to improve gingival health, wherein the emission of heat is temperature-regulated. The method of whitening teeth may include the step of providing a heating element having a light-emitting source configured to emit heat. The method of whitening teeth may include the step of changing phase of the bleaching agent via the transmission of heat from the heating element to the bleaching agent such that a viscosity of the bleaching agent is decreased. The method of whitening teeth may include the step of distributing the decreased viscosity bleaching agent about the surfaces of the teeth. The step of providing may include the engagement portion having bristles and further comprising the step of mechanically moving, such as, for example, vibrating the bristles during engagement with the at least one tooth.

The step of mechanically moving also benefits the distribution of bleaching agent to surfaces of the teeth, whereby direct physical contact of the bristles may be difficult or impracticable. Vibratory motion of the head propagates material over a greater surface area, which enhances activation of the bleaching agent, as described herein. A vibrating step may include engaging the bristles with the gums of a subject in a configuration that improves blood circulation. The step of providing may include the engagement portion having bristles and further comprising the step of vibrating the bristles during engagement with the at least one tooth. The method of whitening teeth may include the step of regulating the temperature adjacent to the engagement portion in a range of about 70° to about 140° F.

In another embodiment, the toothbrush is employed with a peroxide-based bleaching agent in an oral cavity of a subject, the toothbrush including a body having a handle disposed with a neck, which is disposed with a head. The head supporting a heating element that is configured to emit heat for heat activation of the peroxide-based bleaching agent. The head includes bristles mounted therewith, which are configured for engagement with teeth and gums of the oral cavity. The bristles are configured for motion relative to the head via a motorized gear configuration that is disposed within the body. A thermal sensor is disposed with the head adjacent the bristles for sensing temperature adjacent the bristles. A temperature adjacent to the bristles is regulated in a range of about 70° to about 140° F. by a thermal feedback circuit communicating with the thermal sensor and a thermostat disposed with the body to control heat activation of the peroxide-based bleaching agent. An electronic circuit is disposed within the body that communicates with the thermal feedback circuit and an energy source for controlling operation of the toothbrush.

In an alternate embodiment, a method for whitening teeth is provided that includes the steps of: providing a toothbrush employed with a bleaching agent in an oral cavity of a subject, similar to those described herein, providing a bleaching agent; applying the bleaching agent to at least one tooth of the oral cavity; engaging the at least one tooth, applied with bleaching agent, with an engagement portion of a head of the toothbrush; transmitting heat from a heating element of the toothbrush for a first predetermined duration of time, wherein a temperature adjacent to the engagement portion is regulated to control heat activation of the bleaching agent; discontinuing transmission of heat from the heating element upon expiration of the first predetermined duration of time; vibrating the engagement portion during engagement with the at least one tooth for a second predetermined duration of time; and discontinuing vibration of the engagement portion upon expiration of the second predetermined duration of time. It is contemplated that the steps of this method are separate and form a sequence that may be repeated in a continuous cycle. It is further contemplated that the sequence and/or series of steps is not limited in number, repetition or order.

The method may further include the step of emitting heat from a temperature regulated light-emitting source for a third predetermined duration of time. The steps of the method may be repeated in a predetermined number of cycles. The steps may also be repeated in a continuous manner. The durations of time may be uniform. In one embodiment, the first predetermined duration time equals 30 seconds and the second predetermined duration of time equals 10 seconds. In another embodiment, the third predetermined duration time equals 40 seconds.

### BRIEF DESCRIPTION OF THE DRAWING

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawing, as set forth below.

FIG. 1 is a side view of a teeth whitening apparatus, with internal components shown, in accordance with the principles of the present disclosure;

FIG. 2 is a side view of an alternate embodiment of the teeth whitening apparatus illustrated in FIG. 1, with internal components shown;

FIG. 3 is a side view of another alternate embodiment of the teeth whitening apparatus illustrated in FIG. 1, with internal components shown;

FIG. 4 is a side view of another alternate embodiment of the teeth whitening apparatus illustrated in FIG. 1, with internal components shown;

FIG. 5 is a side view of another alternate embodiment of the teeth whitening apparatus illustrated in FIG. 1, with internal components shown; and

FIG. 6 is a side view of another alternate embodiment of the teeth whitening apparatus illustrated in FIG. 1, with internal components shown.

### DETAILED DESCRIPTION OF EXEMPLARY EMBODIMENTS

The exemplary embodiments of the teeth whitening apparatus, composition and methods of use disclosed are discussed in terms of dental health and dental cosmetics and more particularly, in terms of a temperature-regulated, heat-emitting toothbrush that whitens teeth employing temperature regulated heat activation to facilitate fast and efficient treatment of tooth surfaces. It is envisioned that the present disclosure may be employed with a range of teeth whitening applications including portable, in-home and in-office. It is further envisioned that the present disclosure may be used with other medical applications, including diagnostic, treatment and surgical.

The device can be a single hand held device or can be a device that is extra-oral used for the purpose of therapeutic treatment. The device can be a consumer device “at-home” or can be a professional device used “in-office”. The device could have bristles attached to allow cleaning, massage and contact of the oral tissues. The device could be used solely for the purpose of activating chemical compounds or materials in the dental field. As used herein, the term “subject” refers to a human patient or other animal.

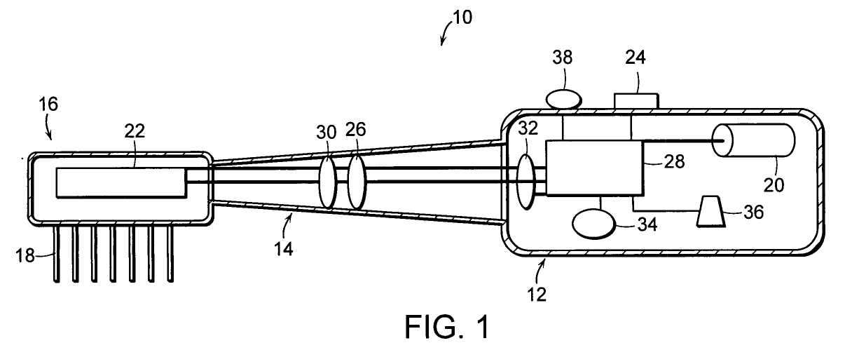

The following discussion includes a description of the teeth whitening apparatus and composition in connection with an exemplary method of operating the teeth whitening apparatus and composition in accordance with the principles of the present disclosure. Alternate embodiments are also disclosed. Reference will now be made in detail to the exemplary embodiments of the present disclosure, which are illustrated in the accompanying figures. Turning now to FIG. 1, there is illustrated a teeth whitening apparatus, such as, for example, a toothbrush 10, in accordance with the principles of the present disclosure.

The components of toothbrush 10 are fabricated from materials suitable for dental applications, such as, for example, polymers or metals, depending on the particular application and/or preference. Semi-rigid and rigid polymers are contemplated for fabrication, as well as resilient materials, such as molded medical grade polyurethane, etc. The electronic and heat generating components of toothbrush 10 may be fabricated from those suitable for a dental application. One skilled in the art, however, will realize that other materials and fabrication methods suitable for assembly and manufacture, in accordance with the present disclosure, also would be appropriate.

Detailed embodiments of the present disclosure are disclosed herein, however, it is to be understood that the described embodiments are merely exemplary of the disclosure, which may be embodied in various forms. Therefore, specific functional details disclosed herein are not to be interpreted as limiting, but merely as a basis for the claims and as a representative basis for teaching one skilled in the art to variously employ the present disclosure in virtually any appropriately detailed embodiment.

Toothbrush 10 includes a body having a handle 12, a neck 14 and a head 16. Head 16 has bristles 18 attached to allow cleaning, massage and contact of oral tissues (not shown). The body of toothbrush 10 may have various configurations and dimensions, according to the particular application, such as, for example, tapered cross section, circular cross section, polygonal, etc.

An energy source 20 is disposed within handle 12 of toothbrush 10 for providing an energy source for a heating element 22. Energy source 20 may be disposed in other portions of toothbrush 10. It is contemplated that energy source 20 may include alternate sources of energy, such as, for example, an A/C power source, rechargeable batteries, replaceable batteries, etc. It is also contemplated that a sealed single-use battery may provide the energy source to heating element 22. Energy source 20 is connected to an electronic circuit board 28, disposed within handle 12, for operating toothbrush 10, as will be discussed. An on/off switch 24 is disposed on handle 12 of toothbrush 10 for connection with electronic circuit board 28 and an on/off indicator 26 of toothbrush 10. Indicator 26 may include a LED, bulb, etc. to provide visual indicia of the on/off status of toothbrush 10.

Toothbrush 10 is employed for the cosmetic whitening of teeth (not shown) through thermal chemical activation processes. Toothbrush 10 activates a chemical bleaching composition through controlled heat activation, which is temperature regulated, as described herein. On/off switch 24 is manipulated to turn toothbrush 10 on, with on/off indicator 26 displaying status via electronic circuit board 28.

On/off switch 24, via electronic circuit board 28, enables powering of heating element 22 from energy source 20. Visual indicia and/or audible indicia is provided that alerts the user to the on/off status of heating element 22. An on/off indicator 30, connected to an electronic circuit board 28, indicates that heating element 22 is transmitting heat energy to adjacent bristles 18. Indicator 30 may include a LED, bulb, etc. to provide visual indicia of the on/off status of heating element 22. It is further envisioned that a light or series of lights on various portions of the body of toothbrush 10 such as, neck 14 and/or handle 12 allows the user to be aware of the status of heating element 22.

Heating element 22 is disposed with head 16 and in an orientation to transmit heat energy adjacent bristles 18. Heating element 22 is configured to transmit heat energy adjacent head 16 and bristles 18 to activate a chemical bleaching composition for cosmetic whitening of a patient's teeth. The temperature or range of temperature can be maintained by use of electronic circuit board 28, which is connected to a thermostat 32 with a feed-back loop circuit of board 28. It is envisioned that thermostat 32 includes a temperature sensor disposed about head 16 and bristles 18 for monitoring temperature adjacent thereto. This configuration is employed to monitor and control the temperature adjacent head 16 and bristles 18 according to the heat being emitted from heating element 22. Thermostat 32 is pre-set such that the upper limit and lower limit of the temperature can be controlled. It is contemplated that a single range of temperature is pre-set for use or that the user would be able to adjust the range of temperature. It is also contemplated that a single temperature could be adjusted. The temperature sensor connected with thermostat 32 may be disposed at various positions about toothbrush 10.

Electronic circuit board 28 and the related circuitry of toothbrush 10 may employ those components known to one skilled in the art that are suitable for a dental application. It is envisioned that toothbrush 10 may include a processor, printed circuit board or microprocessor components that operate and control the components of toothbrush 10, suitable for teeth whitening applications.

The chemical bleaching composition employed with toothbrush 10 is applied to the teeth of a subject. Toothbrush 10 is manipulated to brush the chemical bleaching composition about the teeth and oral cavity as required for a particular dental teeth whitening application. Heating element 22 transmits heat energy to adjacent bristles 18.

A rheostat temperature control 38, connected with electronic circuit board 28, regulates the temperature in a specified range to control transmission of heat energy and corresponding heat activation of the chemical bleaching composition. Rheostat temperature control 38 can be set to pre-defined levels such as, for example, low, medium, high. Alternatively, rheostat temperature control 38 may regulate numerically defined temperature ranges. The chemical bleaching composition may include various teeth whitening agents, such as, for example, gels, powders, pastes, waxes and combinations thereof including hydrogen peroxide based chemicals, carbamide peroxide, calcium peroxide, potassium peroxide, etc. It is contemplated that a plurality of agents or compounds may be employed.

An internal timer 34, connected with electronic circuit board 28, controls the duration of heat energy transmitted from heating element 22 to allow heat activation for a specific amount of time. The length of time can be adjusted according to the particular application. A speaker 36, connected with electronic circuit board 28, provides an audible signal indicating that a specified duration of heat energy transmission has elapsed. In turn, this indicates that use of toothbrush 10 is complete for tooth whitening. It is contemplated that several audible signals could be used to designate specific durations of heat energy transmission corresponding to a particular area of the oral cavity and that it is time to move to another random or predetermined area.

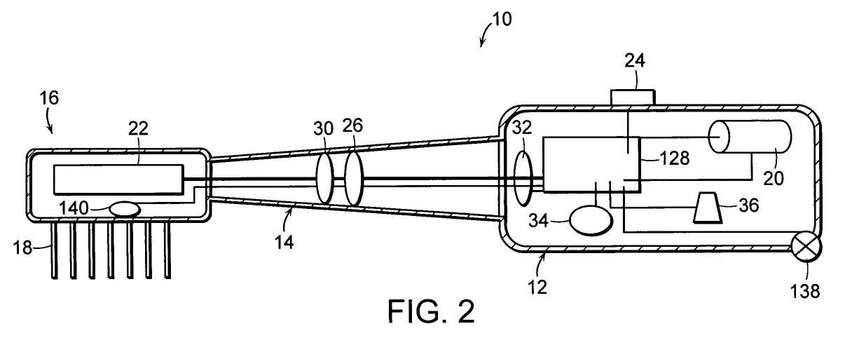

Referring to FIG. 2, an alternate embodiment of toothbrush 10, similar to that described, is shown. An electronic circuit board 128 is disposed with handle 12 of toothbrush 10. Electronic circuit board 128 is connected to the various components of toothbrush 10, similar to electronic circuit board 28 described above.

Electronic circuit board 128 is also connected to a thermal sensor 140 that is disposed with head 16 and adjacent heating element 22. Thermal sensor 140 detects temperature data adjacent head 16 and bristles 18 and sends the temperature data to electronic circuit board 128 and thermostat 32 to monitor and control the temperature of the heat being emitted from heating element 22. Thermal sensor 140 provides continuous feedback to electronic circuit board 128 and thermostat 32 to monitor and control temperature to regulate the process of whitening. It is contemplated that thermal sensor 140 may be disposed at various positions about toothbrush 10. It is further contemplated that thermal sensor 140 may be separate or integrated with heating element 22. Thermal sensor 140 can be disposed within toothbrush 10 or external to toothbrush 10, such as on the surface of head 18 or within a bristle or bristles 18.

A rheostat temperature control 138, connected with electronic circuit board 128, regulates the temperature in a specified range to control transmission of heat energy and corresponding heat activation of the chemical bleaching composition. Rheostat temperature control 138 has a manipulable dial configuration regulating temperature in a defined temperature range. It is contemplated that control 138 may regulate temperature in a temperature range of 70°-140° F. Rheostat temperature control 138 can be manipulated or rotated to a desired temperature.

In operation, similar to that described above, toothbrush 10 includes thermostat 32 that sets a predefined temperature range for heating element 22 for heat activation of a chemical bleaching composition. Heating element 22 generates heat energy corresponding to the preset temperature range. Thermal sensor 140 detects temperature data adjacent head 16 and bristles 18 and sends the temperature data to electronic circuit board 128 and thermostat 32 to monitor and control the temperature adjacent head 16 and bristles 18 according to the heat being emitted from heating element 22. The thermal data from thermal sensor 140 provides the data such that electronic circuit board 128 and thermostat 32 can regulate the temperature to the defined range set by thermostat 32. These elements control a specific range of temperature at the point of application, thereby detecting temperature that is external to electronic circuit board 128 to be used to control the system.

Alternatively, the temperature regulated heat emission from toothbrush 10 for heat activation of the chemical bleaching composition can facilitate a phase change of the composition or agent. For example, the emission of heat from heating element 22 may cause a phase change of the agent, such as from a higher viscosity gel to a liquid of a lower viscosity. This phase change to a lower viscosity more readily distributes the agent about the subject's teeth. This distribution provides for a greater coverage of teeth and lower amount of agent being used.

In another alternate embodiment, thermal sensor 140 may include a filament that detects temperature either within toothbrush 10 or outside toothbrush 10. The filament directs temperature data to electronic circuit board 128 and thermostat 32 to monitor and control the temperature of the heat being emitted from heating element 22. This controller configuration of toothbrush 10 collects temperature data from thermal sensor 140 and directs temperature data to electronic circuit board 128 and thermostat 32. It is contemplated that one or a plurality of filaments may be disposed with bristles 18 to provide direct temperature sensing at the interface of contact to oral cavity surfaces such as the teeth or gums.

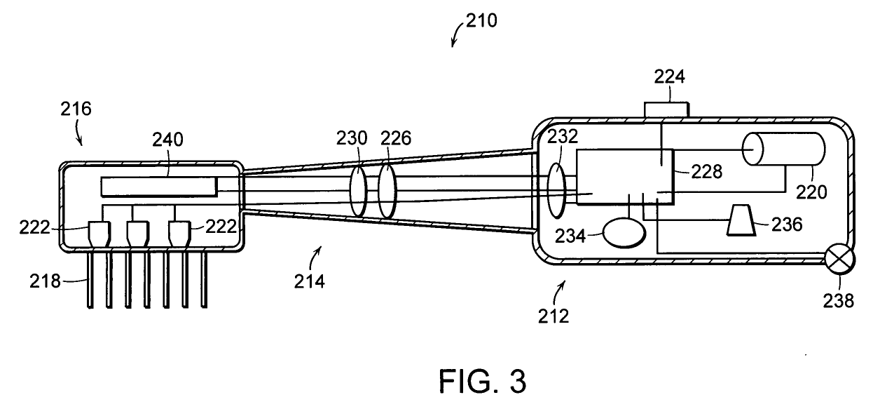

Referring to FIG. 3, an alternate embodiment, similar to toothbrush 10 described above, is shown that includes a toothbrush 210 having a body including a handle 212, a neck 214 and a head 216. Head 216 has bristles 218 attached to allow cleaning, massage and contact of oral tissues (not shown). The body of toothbrush 210 may have various configurations and dimensions, according to the particular application, such as, for example, tapered cross section, circular cross section, polygonal, etc.

An energy source 220 is disposed within handle 212 of toothbrush 210 for providing an energy source for a light-emitting source, such as, for example, light-emitting diodes (LEDs) 222. Energy source 220 may be disposed in other portions of toothbrush 210. It is contemplated that energy source 220 may include alternate sources of energy, such as, for example, an A/C power source, rechargeable batteries, replaceable batteries, etc. It is also contemplated that a sealed single-use battery may provide the energy source to LEDs 222. Energy source 220 is connected to an electronic circuit board 228, disposed within handle 212, for operating toothbrush 210, as will be discussed. An on/off switch 224 is disposed on handle 212 of toothbrush 210 for connection with electronic circuit board 228 and an on/off indicator 226 of toothbrush 210. Indicator 226 may include a LED, bulb, etc. to provide visual indicia of the on/off status of toothbrush 210.

Toothbrush 210 is employed for the cosmetic whitening of teeth (not shown) through thermal chemical activation processes. Toothbrush 210 activates a chemical bleaching composition through controlled heat activation, which is temperature regulated, as described herein. On/off switch 224 is manipulated to turn toothbrush 210 on, with on/off indicator 226 displaying status via electronic circuit board 228.

On/off switch 224, via electronic circuit board 228, enables powering of LEDs 222 from energy source 220. Visual indicia and/or audible indicia is provided that alerts the user to the on/off status of LEDs 222. An on/off indicator 230, connected to an electronic circuit board 228, indicates that LEDs 222 are transmitting heat energy to adjacent bristles 218. Indicator 230 may include a LED, bulb, etc. to provide visual indicia of the on/off status of LEDs 222. It is further envisioned that a light or series of lights on various portions of the body of toothbrush 210 such as, neck 214 and/or handle 212 allows the user to be aware of the status of LEDs 222.

LEDs 222 are disposed with head 216 and in an orientation to transmit heat energy adjacent bristles 218. LEDs 222 are configured to emit visible light adjacent head 216 and bristles 218 within any range of wavelength that produces heat as its by-product. LEDs 222 are configured to transmit heat energy adjacent head 216 and bristles 218 to activate a chemical bleaching composition for cosmetic whitening of a patient's teeth. One or a plurality of LEDs 222 may be employed.

The temperature or range of temperature can be maintained by use of electronic circuit board 228, which is connected to a thermostat 232 with a feedback loop circuit of board 228. It is envisioned that thermostat 232 includes a temperature sensor disposed about head 216 and bristles 218 for monitoring temperature adjacent thereto. For example, electronic circuit board 228 is also connected to a thermal sensor 240 that is disposed with head 216 and adjacent LEDs 222. Thermal sensor 240 detects temperature data adjacent head 216 and bristles 218 and sends the temperature data to electronic circuit board 228 and thermostat 232 to monitor and control the temperature adjacent head 216 and bristles 218 according to the heat being emitted from LEDs 222. Thermal sensor 240 provides continuous feedback to electronic circuit board 228 and thermostat 232 to monitor and control temperature to regulate the process of whitening. It is contemplated that thermal sensor 240 may be disposed at various positions about toothbrush 210. It is further contemplated that thermal sensor 240 may be separate or integrated with LEDs 222. Thermal sensor 240 can be disposed within toothbrush 210 or external to toothbrush 210, such as on the surface of head 216 or within a bristle or bristles 218. This configuration is employed to monitor and control the temperature adjacent head 216 and bristles 218 according to the heat being emitted from LEDs 222.

Thermostat 232 is pre-set such that the upper limit and lower limit of the temperature can be controlled. It is contemplated that a single range of temperature is pre-set for use or that the user would be able to adjust the range of temperature. It is also contemplated that a single temperature could be adjusted. The temperature sensor connected with thermostat 232 may be disposed at various positions about toothbrush 210. It is envisioned that LEDs 222 transmit light energy adjacent head 216 to activate the chemical bleaching composition for cosmetic whitening of a patient's teeth.

Electronic circuit board 228 and the related circuitry of toothbrush 210 may employ those components known to one skilled in the art that are suitable for a dental application. It is envisioned that toothbrush 210 may include a processor, printed circuit board or microprocessor components that operate and control the components of toothbrush 210, suitable for teeth whitening applications.

The chemical bleaching composition employed with toothbrush 210 is applied to the teeth of a subject. Toothbrush 210 is manipulated to brush the chemical bleaching composition about the teeth and oral cavity as required for a particular dental teeth whitening application. LEDs 222 transmit heat energy to adjacent bristles 218. It is contemplated that LEDs 222 can transmit light energy.

A rheostat temperature control 238, connected with electronic circuit board 228, regulates the temperature in a specified range to control transmission of heat energy and corresponding heat activation of the chemical bleaching composition. Rheostat temperature control 238 can be set to pre-defined levels such as, for example, low, medium, high. Rheostat temperature control 238 has a manipulable dial configuration regulating temperature in a defined temperature range. It is contemplated that control 238 may regulate temperature in a temperature range of 70°-140° F. Rheostat temperature control 238 can be manipulated or rotated to a desired temperature. Alternatively, rheostat temperature control 238 may regulate numerically defined temperature ranges.

An internal timer 234, connected with electronic circuit board 228, controls the duration of heat energy transmitted from LEDs 222 to allow heat activation for a specific amount of time. The length of time can be adjusted according to the particular application. A speaker 236, connected with electronic circuit board 228, provides an audible signal indicating that a specified duration of heat energy transmission has elapsed. In turn, this indicates that use of toothbrush 210 is complete for tooth whitening. It is contemplated that several audible signals could be used to designate specific durations of heat energy transmission corresponding to a particular area of the oral cavity and that it is time to move to another random or predetermined area.

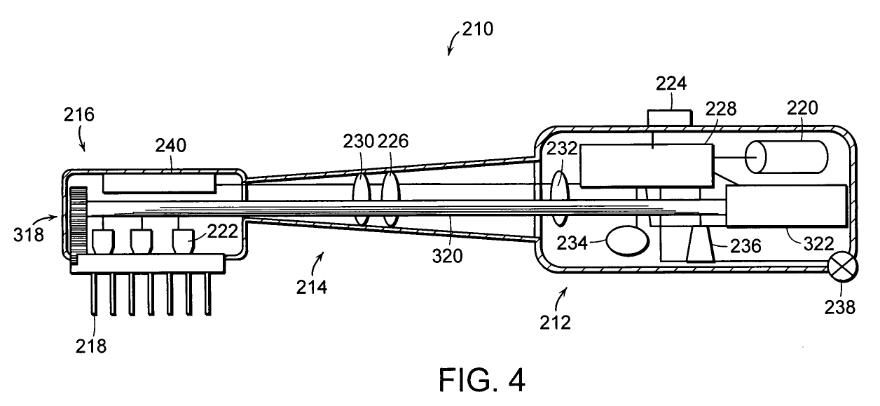

Referring to FIG. 4, an alternate embodiment of toothbrush 210, similar to that described, is shown. Bristles 218, disposed with head 216, are actuated via a bristle gear 318. Bristle gear 318 is linked to a shaft 320 that is connected to a motor 322. Motor 322 is connected to energy source 220 for activation thereof. It is contemplated that bristles 218 may be activated by manual or mechanical structure, including motorized, that can include the necessary electronics and/or processor circuitry to enable activation of bristles 218.

Bristles 218 may be disposed in various arrangements and orientations, including spaced apart, rotating bristle sets, etc. Activation of bristles 218 includes rotation and/or vibratory movement in various directions. Such movement of bristles 218 may include rotatable, vertical, horizontal and elliptical motion. Bristles 218 may also be heated with a filament and/or contain a therapeutic agent.

Motor 322 is connected to electronic circuit board 228 for operation and activation of bristles 218. It is contemplated that motor 322 may be connected with thermal sensor 240 such that a specific temperature or temperature range causes shut-off of bristle 218 activation. Bristles 218 may include continuous movement and/or periodic timed activation.

Activation of bristles 218 enhances cleaning, massage and contact of oral tissues. This configuration also enhances dispersal of a chemical bleaching composition about the teeth to facilitate teeth whitening.

In operation, similar to that described above, toothbrush 210 includes thermostat 232 that sets a predefined temperature range for LEDs 222 for heat activation of a chemical bleaching composition. LEDs 222 generate heat energy corresponding to the preset temperature range. Thermal sensor 240 detects temperature data adjacent head 216 and bristles 218 and sends the temperature data to electronic circuit board 228 and thermostat 232 to monitor and control the temperature adjacent head 216 and bristles 218 according to the heat being emitted from LEDs 222. The thermal data from thermal sensor 240 provides the data such that electronic circuit board 228 and thermostat 232 can regulate the temperature to the defined range set by the thermostat 232. These elements control a specific range of temperature at the point of application, thereby detecting temperature that is external to electronic circuit board 228 to be used to control the system.

Alternatively, the temperature regulated heat emission from toothbrush 210 for heat activation of the chemical bleaching composition can facilitate a phase change of the composition or agent. For example, the emission of heat from heating element 222 may cause a phase change of the agent, such as from a higher viscosity gel to a liquid of a lower viscosity. This phase change to a lower viscosity more readily distributes the agent about the subject's teeth. This distribution provides for a greater coverage of teeth and lower amount of agent being used. This phase change of the agent may also be accompanied by vibratory action of head 216 and/or bristles 218 to facilitate enhanced distribution of the agent about the surfaces of the teeth.

In another alternate embodiment, toothbrush 210, similar to that described with regard to FIGS. 3 and 4, activates a chemical teeth whitening agent, such as a whitening gel or toothpaste, in a two phase activation cycle. For example, LEDS 222 emit heat, as described, in a first phase that employs heat to cause the molecules of the agent or compound to become excited and reactive for teeth whitening applications. In a second phase, the light emitted from LEDS 222 would cause a further and separate excitation and reaction of the compound molecules for teeth whitening. Thus, toothbrush 210 employs a first phase of heat emission and a second phase of light emission for separate chemical reactions in a single teeth whitening application. This two phase activation cycle may include vibratory action, as discussed.

In another alternate embodiment, similar to that described with regard to FIGS. 3 and 4, toothbrush 210 is employed with a method of teeth whitening that includes a series of predefined steps. Toothbrush 210, similar to those described, is provided and the chemical bleaching agent employed with toothbrush 210 is applied to the teeth of a subject. Toothbrush 210 is manipulated to brush the chemical bleaching agent about the teeth and oral cavity. Bristles 218 engage the teeth, applied with the bleaching agent. Heat is transmitted from heating element 22, described with regard to FIGS. 1 and 2 and mounted with toothbrush 210, for a first predetermined duration of time, such as, for example, 30 seconds. Temperature adjacent head 216 and/or bristles 218 is regulated to control heat activation of the bleaching agent. Upon expiration of the first predetermined duration of time, transmission of heat from heating element 22 is discontinued.

Head 216 and/or bristles 218 are mechanically moved, such as, for example, by vibrating head 216 and/or bristles 218 during engagement with the teeth for a second predetermined duration of time, such as, for example, 10 seconds. Upon expiration of the second predetermined duration of time, vibration of head 216 and/or bristles 218 is discontinued.

Heat is transmitted from LEDS 222, described with regard to FIGS. 3 and 4, for a third predetermined duration of time, such as, for example, 40 seconds. Temperature adjacent head 216 and/or bristles 218 is regulated to control heat activation of the bleaching agent. Upon expiration of the third predetermined duration of time, transmission of heat from LEDS 222 is discontinued. It is contemplated that the steps of this method are separate and form a sequence that may be repeated in a continuous cycle. It is further contemplated that the sequence and/or series of steps is not limited in number, repetition or order. The steps of the method may be repeated in a predetermined number of cycles. The durations of time may be uniform.

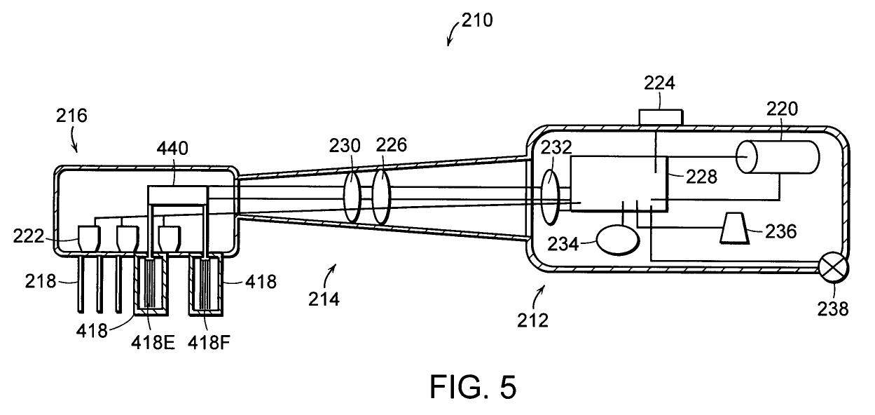

Referring to FIG. 5, another alternate embodiment of toothbrush 210, similar to that described, is shown. Head 216 includes bristles 218 and filament bristles 418 that allow for thermal conduction, via an embedded conductor of thermal energy. An embedded conductor 418E is fabricated from metal, such as a wire, or a composite material. Conductor 418E facilitates the emission of heat from the corresponding bristle 418. This configuration allows for more efficient conductivity of thermal energy or heat to the whitening agent and direct surfaces of the teeth during use. It is envisioned that toothbrush 210 may employ one or a plurality of filament bristles 418.

Head 216 also includes filament bristle 418 that has an embedded conductive element 418F that collects information regarding temperature. Conductive element 418F feeds such information back to the thermal feedback circuit of electronic circuit board 228, via a thermal sensor heat element 440, for temperature regulation of the heat activation provided by toothbrush 210.

It is contemplated that filament bristle 418 could be a hollow cylindrical tube that allows transmission of the thermal energy within hollow bristle 418 to a conductive element either within or at the proximal end thereof. This hollow bristle 418 allows detection of thermal changes at the surfaces of the teeth. It is further contemplated that fluid from within the oral cavity or water used to moisten bristles 218, 418 prior to use would become a conductor of the thermal energy at the surfaces of the teeth.

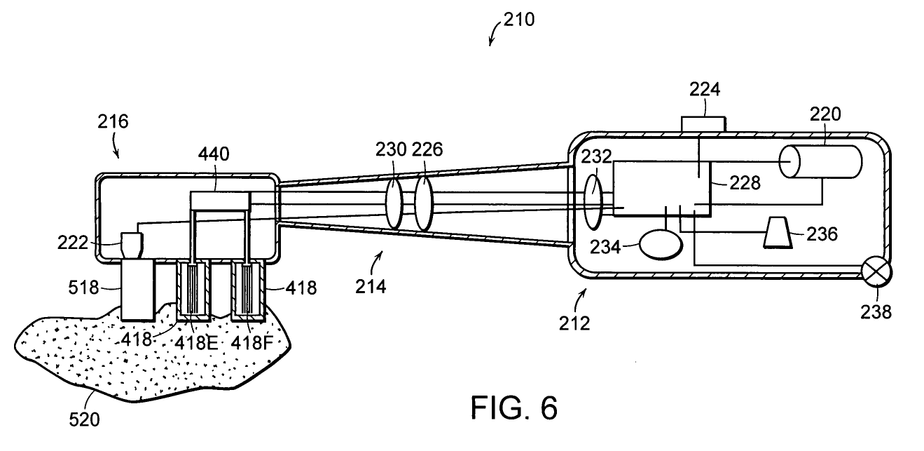

Referring to FIG. 6, another alternate embodiment of toothbrush 210, similar to that discussed with regard to FIG. 5, is shown. Toothbrush 210 has head 216 that includes bristles 418, similar to those described with regard to FIG. 5, and a fiber-optic filament bristle 518. Fiber-optic filament bristle 518 provides light emitting wave propagation that travels from LED 222 within head 216 down bristle 518 to have the light emit therefrom directly to surfaces of the teeth to within a bleaching agent, such as a whitening gel or toothpaste.

It is contemplated that head 216 may include one or a plurality of fiber-optic filament bristles 518. The advantage to this design is to allow the light energy to be directed within a whitening gel 520 for improved light penetration within the gel. This results in a more efficient and effective activation of the gel. Thus, toothbrush 210 utilizes a fiber-optic filament bristle 518 that allows light energy to be emitted throughout gel 520 resulting in enhanced whitening of teeth surfaces. Direct contact of light energy within the depth of gel 520 insures a uniform effect of the light emitting energy throughout gel 520.

In another alternate embodiment, thermal sensor 240 may include a filament that detects temperature either within toothbrush 210 or outside toothbrush 210. The filament directs temperature data to electronic circuit board 228 and thermostat 232 to monitor and control the temperature of the heat being emitted from LEDs 222. This controller configuration of toothbrush 210 collects temperature data from thermal sensor 240 and directs temperature data to electronic circuit board 228 and thermostat 232. It is contemplated that one or a plurality of filaments may be disposed with bristles 218 to provide direct temperature sensing at the interface of contact to oral cavity surfaces such as the teeth or gums.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A toothbrush employed with a bleaching agent in an oral cavity of a subject, the toothbrush comprising:
a body having a head and a heating element disposed with the head, the heating element being configured to emit heat for heat activation of the bleaching agent,
the head including an engagement portion, which is configured for engagement with at least a portion of the oral cavity, and a thermal sensor disposed therewith, the thermal sensor being configured to sense temperature adjacent the engagement portion of the head,
wherein a temperature adjacent the engagement portion is regulated by a thermal feedback circuit communicating with the thermal sensor and a thermostat disposed with the body to control heat activation of the bleaching agent.

2. A toothbrush as recited in claim 1, wherein the heating element includes a light-emitting source configured to emit heat.

3. A toothbrush as recited in claim 1, wherein the engagement portion includes bristles.

4. A toothbrush as recited in claim 3, wherein the bristles are rotatable.

5. A toothbrush as recited in claim 1, wherein the engagement portion is moveable relative to the head.

6. A toothbrush as recited in claim 1, wherein the engagement portion is moveable via motorized actuation.

7. A toothbrush as recited in claim 1, wherein the engagement portion vibrates.

8. A toothbrush as recited in claim 1, wherein the engagement portion is configured for engagement with teeth and gums of the subject.

9. A toothbrush as recited in claim 1, further comprising an electronic circuit disposed within the body, which communicates with the thermal sensor, the thermostat, and an energy source for controlling operation of the toothbrush.

10. A toothbrush as recited in claim 1, wherein the thermostat has a predetermined upper limit and a predetermined lower limit.

11. A toothbrush as recited in claim 1, wherein the temperature adjacent the engagement portion is regulated in a range of about 70° to about 140° F.

12. A toothbrush as recited in claim 3, wherein the heating element includes filaments disposed with and configured to heat the bristles.

13. A toothbrush as recited in claim 3, wherein the thermal sensor includes filaments disposed with and configured to sense temperature adjacent the bristles.

14. A toothbrush as recited in claim 9, further comprising a rheostat temperature control disposed with the body that communicates with the electronic circuit in a configuration that controls the temperature adjacent the engagement portion at a predefined value.

15. A toothbrush as recited in claim 9, further comprising a timer disposed with the body that communicates with the electronic circuit in a configuration that transmits heat energy for a predetermined amount of time.

16. A toothbrush as recited in claim 15, wherein the electronic circuit communicates with a device, disposed with the body, that generates an audible signal upon duration of the predetermined amount of time.

17. A method for whitening teeth comprising the steps of:
providing a toothbrush employed with a bleaching agent in an oral cavity of a subject, the toothbrush including:
a body having a head and a heating element disposed with the head, the heating element being configured to emit heat for heat activation of the bleaching agent,
the head including an engagement portion, which is configured for engagement with at least a portion of the oral cavity, and a thermal sensor disposed therein, the thermal sensor being configured to sense temperature adjacent the engagement portion of the head,
wherein a temperature adjacent the engagement portion is regulated by a thermal feedback circuit communicating with the thermal sensor and a thermostat disposed with the body to control heat activation of the bleaching agent;
providing a bleaching agent;
applying the bleaching agent to at least one tooth of the oral cavity;
engaging the at least one tooth, applied with bleaching agent, with the engagement portion of the head; and
transmitting heat from the heating element, wherein a temperature adjacent the engagement portion is regulated to control heat activation of the bleaching agent.

18. A method of whitening teeth as recited in claim 17, further comprising the step of emitting heat from the heating element in a configuration that reduces an amount of micro-organisms to improve gingival health, wherein the emission of heat is temperature-regulated.

19. A method of whitening teeth as recited in claim 17, wherein the step of providing includes the heating element having a light-emitting source configured to emit heat.

20. A method of whitening teeth as recited in claim 17, further comprising the step of changing phase of the bleaching agent via the transmission of heat from the heating element to the bleaching agent such that a viscosity of the bleaching agent is decreased.

21. A method of whitening teeth as recited in claim 20, further comprising the step of distributing the decreased viscosity bleaching agent about the at least one tooth.

22. A method of whitening teeth as recited in claim 17, wherein the step of providing includes the engagement portion having bristles and further comprising the step of vibrating the bristles during engagement with the at least one tooth.

23. A method of whitening teeth as recited in claim 22, wherein the step of vibrating includes engaging the bristles with the gums of the subject in a configuration that improves blood circulation.

24. A method of whitening teeth as recited in claim 19, wherein the step of providing includes the engagement portion having bristles and further comprising the step of vibrating the bristles during engagement with the at least one tooth.

25. A method of whitening teeth as recited in claim 17, further comprising the step of regulating the temperature adjacent the engagement portion in a range of about 70° to about 140° F.

26. A toothbrush employed with a peroxide-based bleaching agent in an oral cavity of a subject, the toothbrush comprising:
a body having a handle disposed with a neck, which is disposed with a head, the head supporting a heating element that is configured to emit heat for heat activation of the peroxide-based bleaching agent;
the head including bristles mounted therewith, which are configured for engagement with teeth and gums of the oral cavity, the bristles being configured for motion relative to the head via a motorized gear configuration that is disposed within the body;
a thermal sensor being disposed with the head adjacent the bristles for sensing temperature adjacent the bristles;
wherein a temperature adjacent the bristles is regulated in a range of about 70° to about 140° F. by a thermal feedback circuit communicating with the thermal sensor and a thermostat disposed with the body to control heat activation of the peroxide-based bleaching agent; and
an electronic circuit disposed within the body that communicates with the thermal feedback circuit and an energy source for controlling operation of the toothbrush.

27. A toothbrush as recited in claim 26, wherein the heating element includes a light-emitting source configured to emit heat.

28. A teeth whitening apparatus employed with a bleaching agent in an oral cavity of a subject, the teeth whitening apparatus comprising:
a body having a head and a heating element that is configured to emit heat energy for heat activation of the bleaching agent; and
the head including an engagement portion, which is configured for engagement with at least a portion of the oral cavity, and a thermal sensor disposed therein, the thermal sensor being configured to sense temperature adjacent the engagement portion of the head,
wherein a temperature adjacent the engagement portion is regulated by a thermostat, disposed with the body and in communication with the thermal sensor, to control heat activation of the bleaching agent.

29. A toothbrush as recited in claim 3, wherein at least one of the bristles has a filament configuration that includes an embedded conductor that generates heat such that the filament bristle is configured to emit heat for heat activation of the bleaching agent.

30. A toothbrush as recited in claim 29, wherein at least one of the bristles has a filament configuration that includes an embedded conductive element that monitors temperature adjacent the engagement portion and communicates such temperature to the thermal feedback circuit.

31. A toothbrush as recited in claim 3, wherein at least one of the bristles includes a fiber-optic filament.

32. A method for whitening teeth comprising the steps of providing a toothbrush employed with a bleaching agent in an oral cavity of a subject, the toothbrush including:
a body having a head and a heating element disposed with the head, the heating element being configured to emit heat for heat activation of the bleaching agent,
the head including an engagement portion, which is configured for engagement with at least a portion of the oral cavity, and a thermal sensor disposed therein, the thermal sensor being configured to sense temperature adjacent the engagement portion of the head,
wherein a temperature adjacent the engagement portion is regulated by a thermal feedback circuit communicating with the thermal sensor and a thermostat disposed with the body to control heat activation of the bleaching agent,
providing the bleaching agent;
applying the bleaching agent to at least one tooth of the oral cavity;
engaging the at least one tooth, applied with the bleaching agent, with the engagement portion of the head;
transmitting heat from the heating element for a first predetermined duration of time, wherein a temperature adjacent the engagement portion is regulated to control heat activation of the bleaching agent;
discontinuing transmission of heat from the heating element upon expiration of the first predetermined duration of time;
vibrating the engagement portion during engagement with the at least one tooth for a second predetermined duration of time; and
discontinuing vibration of the engagement portion upon expiration of the second predetermined duration of time.

33. A method for whitening teeth as recited in claim 32, further comprising the step of emitting heat from a temperature regulated light-emitting source for a third predetermined duration of time.

34. A method for whitening teeth as recited in claim 32, wherein the steps are repeated in a predetermined number of cycles.

35. A method for whitening teeth as recited in claim 32, wherein the steps are repeated continuously.

36. A method for whitening teeth as recited in claim 32, wherein the durations of time are uniform.

37. A method for whitening teeth as recited in claim 32, wherein the first predetermined duration of time equals about 30 seconds and the second predetermined duration of time equals about 10 seconds.

38. A method for whitening teeth as recited in claim 33, wherein the third predetermined duration of time equals about 40 seconds.
